(19) United States
(12) Patent Application Publication
(10) Pub. No.: US 2026/0157571 A1
(43) Pub. Date: Jun. 11, 2026

(54) GRINDING DEVICE FOR GRINDING DRY HERBS AND THE LIKE

(71) Applicant: Franco Lewenstein Industries LTD, Tortola (VG)

(72) Inventor: Isaac Paul Franco, Tel Aviv (IL)

(21) Appl. No.: 18/973,012

(22) Filed: Dec. 8, 2024

(51) Int. Cl. A47J 42/26; A47J 42/46

(52) U.S. Cl. CPC A47J 42/26; A47J 42/46

(57) ABSTRACT

A grinding device for grinding dry herbs and leaf is disclosed. The grinding device includes a first plate having a plurality of first pegs, and a second plate having a plurality of second pegs. The grinding device includes a bearing positioned at the first plate. Further, the grinding device includes a central axis pillar positioned at the second plate. The central axis pillar inserts in the bearing such that the first plate and the second plate do not have an active contact while the plurality of first pegs and the plurality of second pegs operatively connect for grinding an herb material. The central axis pillar eliminates friction during grinding by ensuring walls of the first plate and the second plate do not come in contact. The grinding device allows for grinding herb material of various sizes without contamination and with minimal effort. The grinding device can also be operated using a motor.

### BACKGROUND OF THE INVENTION

### Field of the Invention

The present invention relates to a grinding device. More specifically, the present invention relates to a grinding device for grinding dry herbs such as cannabis.

### Description of the Prior Art

Dry, frozen, and fresh leaf herbs, such as cannabis, are natural products that are used for both medicinal and recreational purposes. Consumers of cannabis grind the herbs before their use in a variety of forms. Typically, herb grinders are used to grind the herbs. Conventional herb grinders are made up of metal or plastic and include two main parts, such as a top grinding plate and a bottom grinding plate. The grinding plates are placed one on top of the other and are rotated to grind the herb material. Specifically, the herb material is placed over the bottom grinding plate and the top grinding plate is rotated/twisted to grind the material.

Several herb grinders have been disclosed in the past. One such example is disclosed in a U.S. Pat. No. 11,399,662, entitled “Manual rotary mill for plant material” (“the '662 Patent”). The '662 Patent discloses a manual mill that indicates through force feedback and free spin the completion of processing of the material inside through shearing, grating, and crumbling, without the use of teeth or protrusions, with easy grip-and-lift access to said processed material.

Another example is disclosed in a U.S. Publication No. 2020237158, entitled “Bearing Herb Grinder” (“the '158 Publication”). The '158 Publication discloses a grinder comprising a bearing track and a plurality of bearing elements such as ball bearings or roller bearings. Optionally, the bearing elements are protected from fouling or contamination from the material being ground, which can be, for example, herbs, spices, tobacco.

Another example is disclosed in a U.S. Pat. No. 9,392,908, entitled “Herb grinder” (“the '908 Patent”). The '908 Patent discloses a shredder or grinder for dried material such as herbs or dried leaves. The shredder is a cylindrical container formed of a top element and a base element forming a chamber, the top element and the base element each having a series of concentrically arranged teeth on a base plate, wherein the teeth that slidably engage one another in a slicing motion to form grinding surfaces against one another, wherein the teeth are serrated to efficiently grind the dried materials in the chamber when the teeth engage one another and are counter rotated relative to one another. In one embodiment the chamber discharges the ground contents through orifices in the base element, where the size is regulated by a screen, and in another embodiment, the ground contents remain in the chamber until the grinding head is removed.

Yet another example is disclosed in a U.S. Pat. No. 11,207,695, entitled “Herb grinder and blades for herb grinder” (“the '695 Patent”). The '695 Patent discloses a grinder having a bottom with a first row of first asymmetrical blades extending from the bottom. A top of the grinder has a second row of second asymmetrical blades extending from the top. The first asymmetrical blades and second asymmetrical blades are triangle shaped. A first side of each blade has one point, and a second side of each blade has two points.

Although the above discussed herb grinders are useful, they have a few drawbacks. For instance, most of the herb grinders are made using metal or plastic material. As a result, the herb grinders produce friction due to rims of both the top and bottom grinding plates making contact as they rotate against each other. The friction between the large contact surface areas of the rims require significant effort from the user to overcome it. This makes the grinding motion difficult and fatiguing, especially for consumers with limited hand strength. Further, due to the friction, material particles from the plates themselves (plastic or aluminum) contaminate the herb and the same gets consumed unintentionally by the user.

Therefore, there is a need in the art to provide an improved grinding device that eliminates physical contact between the plates, results in much less effort needed to grind the material, and eliminates plate particles contaminating the grind material or material getting stuck in the grinding teeth.

There is also a need in the art to provide an improved grinding device that can be used with a motorized base, and where a user can control the distance between the plates for a fine or a coarse grind.

### SUMMARY OF THE INVENTION

It is an object of the present invention to provide an improved grinding device that removed physical contact between the top and bottom plates.

It is another object of the present invention to provide a grinding device that prevents plate particles from contaminating the grind material or herb material.

It is yet another object of the present invention to provide a grinding device that offers a minimal friction, and contamination-free design for the precise grinding of herb materials like cannabis.

It is yet another object of the present invention to provide a grinding device that incorporates a mechanism for controlling the distance between the plates thereby controlling the grind particle size accurately.

In order to achieve one or more of these objects, the present invention provides a grinding device for grinding dry, frozen, and wet herbs. The grinding device includes a first plate having a plurality of first pegs and a second plate having a plurality of second pegs. The grinding device includes a bearing positioned at the first plate. Further, the grinding device includes a central axis pillar positioned at the second plate. The central axis pillar inserts in the bearing such that the first and second plates do not make active contact with each other, while the plurality of first pegs and the plurality of second pegs operate to grind a herb material. In addition, the insertion of the central axis pillar in the bearing makes it easier to assemble and disassemble.

In one aspect of the present invention, the first plate includes a first wall or first rim at its circumference. The first wall extends perpendicularly from the surface of the first plate. Further, the second plate includes a second wall or second rim at its circumference. The second wall extends perpendicularly from the surface of the second plate. In some configurations, the first wall and the second wall present a gap, indicating no contact between the walls when the second plate sits on top of the first plate.

In another aspect of the present invention, the first pegs are positioned in an upward tapered manner and the second pegs are positioned in a downward tapered manner such that they overlap and shred the herb material placed between the first plate and the second plate, when a user rotates the first plate relative to the second plate or vice versa. In addition, a user may rotate both the first and second plates in opposite directions simultaneously. The first pegs and the second pegs are arranged concentrically in a circular pattern to optimize the grinding surface for the herb material. The first pegs and the second pegs are designed to grind herbs of varying sizes.

In one advantageous feature of the present invention, the central axis pillar and the bearing connection allows smooth, low-friction rotation of the second plate over the first plate during operation while maintaining the gap. The central axis pillar and bearing connection maintains the gap between the walls of the first and second plates, preventing contact that could cause abrasive wear and tear and particulate contamination. In other words, the first plate and second plate are suspended around each other around a central axis pillar connected to the bearing, which removes physical contact between the plates. This design significantly reduces the effort required to grind the material, minimizes wear and tear on the grinder's components, and removes the risk of plate particles contaminating the grind material.

In another advantageous feature of the present invention, the grinding device can be operatively connected to a motor assembly that acts as a base unit. The motor assembly rotates the first or the second plate at an optimized speed for grinding the herb material. As such, the grinding device offers motorized or dual usage i.e., manual/automated capability depending on the need.

In another advantageous feature of the present invention, the ability to adjust the distance between the first and second plates enables the user to customize the grind level, allowing for efficient processing of herb materials of varying sizes.

In another advantageous feature of the present invention, each peg is designed with a diamond shaped tooth configuration. The sharp edges and precise geometry of the teeth allows the pegs to effectively slice the material rather than tearing it, ensuring efficiency and consistency in the quality of the herbs after grinding.

These and other objects of the present invention will be apparent from review of the following specification and the accompanying drawings.

### BRIEF DESCRIPTION OF THE DRAWINGS

FIG. 1 and FIG. 2 illustrate a perspective view and a cross-sectional view, respectively of a grinding device, in accordance with one embodiment of the present invention.

FIG. 3 illustrates a first part and a second part of the grinding device laid out in an open configuration, in accordance with one embodiment of the present invention.

FIG. 4 is a perspective view of the first part, in accordance with one embodiment of the present invention.

FIG. 5 is an enlarged view of a first plate, in accordance with one embodiment of the present invention.

FIG. 6 is an enlarged view of first pegs arranged on the first plate, in accordance with one embodiment of the present invention.

FIG. 7 is a bottom perspective view of the first peg, in accordance with yet one embodiment of the present invention.

FIG. 8A, FIG. 8B and FIG. 8C illustrate different sizes of herb material placed within the grinding device, in accordance with one embodiment of the present invention.

FIG. 9A, FIG. 9B, FIG. 9C and FIG. 9D illustrate a front view, a perspective view, a bottom view and a top view, respectively of a grinding device, in accordance with yet another embodiment of the present invention.

FIG. 10 is a cross-sectional view of the grinding device, in accordance with one embodiment of the present invention.

FIG. 11A, FIG. 11B, FIG. 11C and FIG. 11D illustrate a front view, a perspective view, a top view and a bottom view, respectively of a grinding device, in accordance with another embodiment of the present invention.

FIG. 12 is a cross-sectional view of the grinding device, in accordance with one embodiment of the present invention.

FIG. 13 is a cross-sectional view of a third part of the grinding device, in accordance with one embodiment of the present invention.

FIG. 14 is a cross-sectional view of a grinding device, in accordance with another embodiment of the present invention.

FIG. 15 is a perspective view of a grinding device having a motor, in accordance with another embodiment of the present invention.

FIG. 16 is an exploded view of the grinding device, in accordance with one embodiment of the present invention.

### DETAILED DESCRIPTION OF THE PREFERRED EMBODIMENT

The detailed description set forth below in connection with the appended drawings is intended as a description of exemplary embodiments in which the presently disclosed subject matter may be practiced. The term “exemplary” used throughout this description means “serving as an example, instance, or illustration,” and should not necessarily be construed as preferred or advantageous over other embodiments. The detailed description includes specific details for providing a thorough understanding of the presently disclosed grinding device. However, it will be apparent to those skilled in the art that the presently disclosed subject matter may be practiced without these specific details. In some instances, well-known structures and grinding devices are shown in functional or conceptual diagram form in order to avoid obscuring the concepts of the presently disclosed grinding device.

In the present specification, an embodiment showing a singular component should not be considered limiting. Rather, the subject matter preferably encompasses other embodiments including a plurality of the same component, and vice-versa, unless explicitly stated otherwise herein. Moreover, the applicant does not intend for any term in the specification to be ascribed an uncommon or special meaning unless explicitly set forth as such. Further, the present subject matter encompasses present and future known equivalents to the known components referred to herein by way of illustration.

Although the present subject matter describes a grinding device, it is to be further understood that numerous changes may arise in the details of the embodiments of the grinding device. It is contemplated that all such changes and additional embodiments are within the spirit and true scope of this subject matter.

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the subject matter and are not intended to limit the scope of the subject matter.

Various features and embodiments of a grinding device for grinding herb [0041] material or dry herbs are explained in conjunction with the description of FIGURES (FIGS. 1-16.

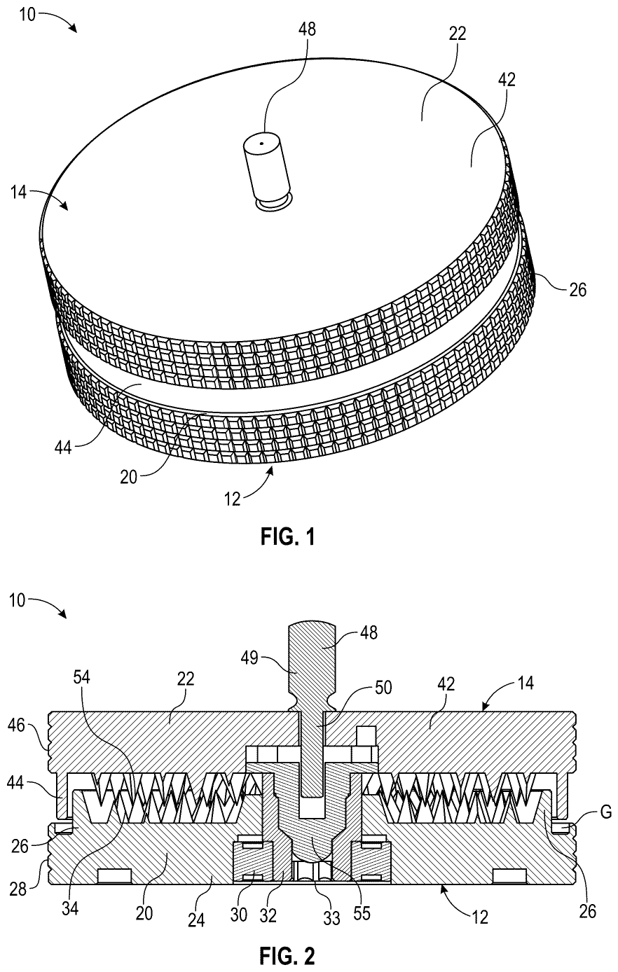

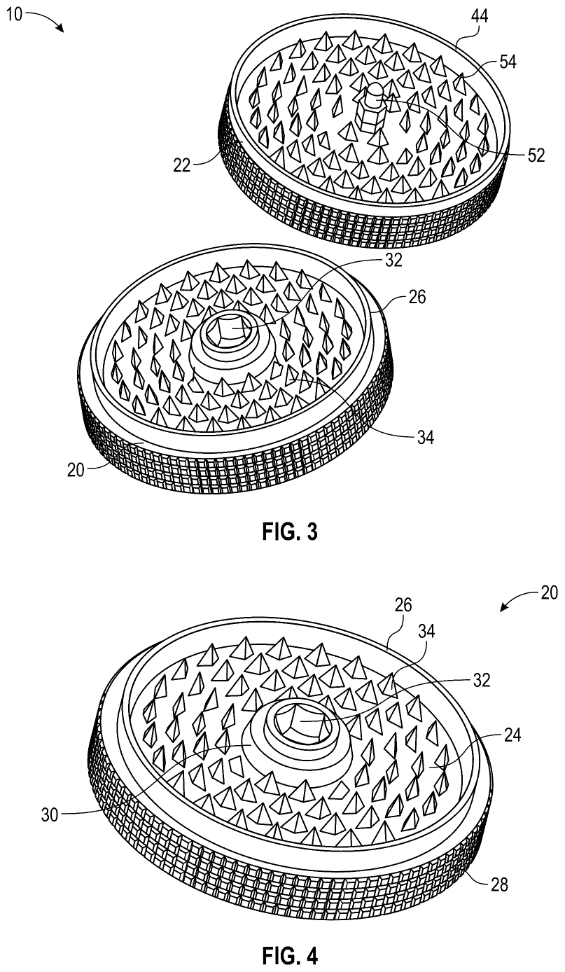

FIG. 1 and FIG. 2 show a perspective view and a cross-sectional view, respectively of a grinding device 10, in accordance with one embodiment of the present invention. The grinding device 10 may also be referred to as an herb grinder, herb crusher, or bearing loaded grinding device. The grinding device 10 includes a first end 12 and a second end 14. The first end 12 indicates a bottom end and second end 14 indicates a top end. The grinding device 10 includes a first part 20 and a second part 22. FIG. 3 shows the first part 20 and second part 22 laid out flat in an open configuration, in accordance with one embodiment of the present invention. The first part 20 indicates a bottom container and second part 24 indicates a top container. Each of the first part 20 and the second part 22 can be made using hard plastic or metal or any other suitable material.

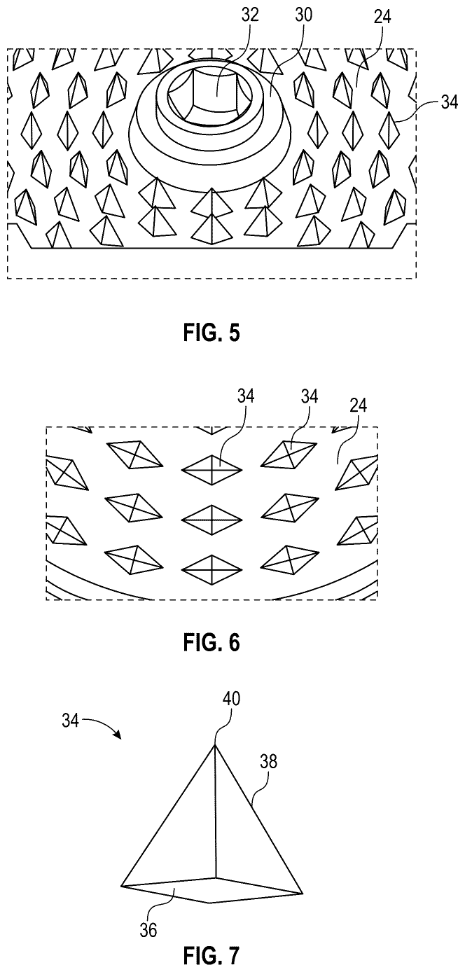

The first part 20 includes a first plate 24. FIG. 4 shows a perspective view of the first part 20, in accordance with one embodiment of the present invention. The first plate 24 comes in a relatively flat configuration. In other embodiments, the first plate 24 may come in a curved configuration. As can be seen from at least FIG. 1, the first plate 24 comes in a circular and flat configuration. The first plate 24 presents a first wall 26. The first wall 26 extends towards the second end 22 from the first plate 24. It should be understood that first wall 26 extends from the outer circumference of the first plate 24. In one example, the first plate 24 encompasses first ridges or a first ribbed portion 28 at the outer portion or circumference. The first ridges 28 act as gripping portions for rotating or twisting the first part 20 with respect to the second part 22. The first plate 24 includes a raised portion 30 having a bearing 32. FIG. 5 shows an enlarged view of first plate 24 showing raised portion 30 having the bearing 32, in accordance with one embodiment of the present invention. Raised portion 30 positions at the center of the first plate 24. Further, the first plate 24 encompasses a plurality of first teeth or first pegs or first bristles or first spikes 34. FIG. 6 shows an enlarged view of the first pegs 34 arranged on the first plate 24. In accordance with one embodiment of the present invention, the first spikes can be diamond shaped, square shaped, triangle shaped or any other shape. The first pegs 34 can be arranged in a series of circular configurations. In one example, the first pegs 34 can be arranged in an irregular manner. It is preferable to arrange the first pegs in a circular pattern to allow proper alignment with the second pegs 52 on the second plate 44. The first pegs 34 are made of hard plastics or metal or any other suitable material. Now referring to FIG. 7, a bottom perspective view of the first peg 34 is shown, in accordance with one embodiment of the present invention. The first peg 34 includes a base 36. The base 36 rests against the first plate 24. The first peg 34 includes a tapered section 38 extending from the base 36. Further, the first peg 34 includes a tip 40 at the distal end of a tapered section 38. The first peg 34 is designed for optimal grinding performance, effectively slicing the material instead of tearing due to its geometry and sharp edge. In some embodiments, the first peg 34 may be diamond, hexagonal, or square shaped, among other shapes. Furthermore, in some embodiments, the diamond shape is 3×4×5 millimeters.

Referring back to FIG. 2, the constructional features of the second part 22 are explained. The second part 22 encompasses a second plate 42. The second plate 42 comes in a relatively flat configuration. Optionally, the second plate 42 may come in a curved configuration. As can be seen from at least FIG. 1 and FIG. 3, the second plate 42 comes in a circular configuration. The second plate 42 presents a second wall 44. The second wall 44 extends towards first end 20 from the second plate 42. In one example, the second plate 42 encompasses second ridges or a second ribbed portion 46 at the outer portion or circumference. The second ridges 46 act as gripping portions for rotating or twisting the second part 22 with respect to the first part 20. Further, the second plate 42 encompasses a plurality of second teeth or second pegs or second bristles or second spikes 54, similar to the first pegs 34 on the first plate 24.

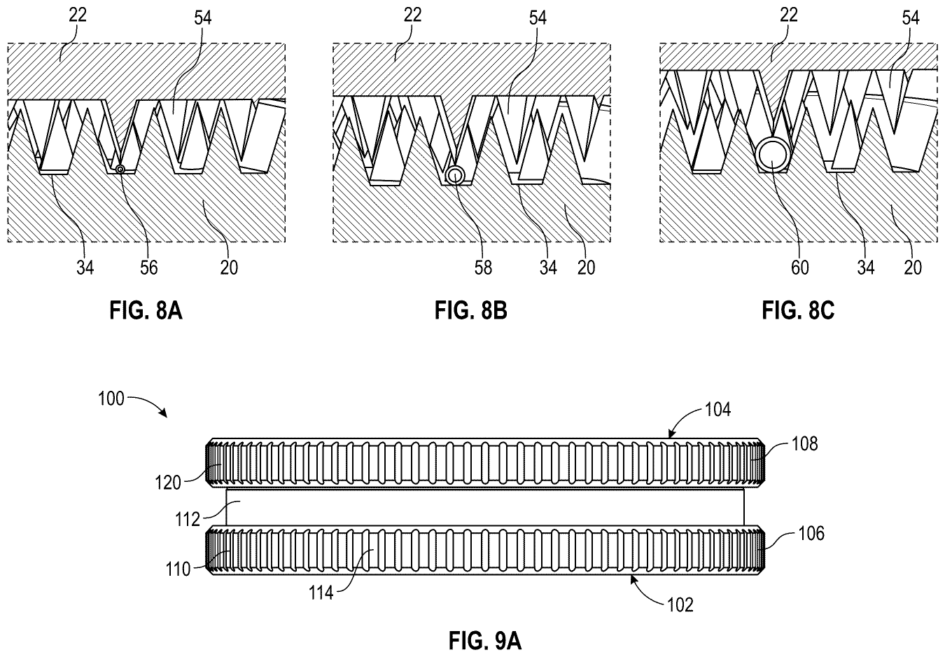

In accordance with one embodiment, the grinding device 10 encompasses a central axis pillar 48. The central axis pillar 48 has a head 49 and a shaft 50 extending from head 49. Here, the shaft 50 includes a curved tip 55. The curved tip 55 positions at the distal end of the shaft 50 and sits in bearing 32 for forming a connection between the first part 20 and the second part 22. In the present embodiment, when the second part 22 sits on top of the first part 20, the first wall 26 sits within the second wall 44 leaving a gap G indicating that the connection between the first part 20 and the second part 22 is maintained by the central axis pillar 48 sitting in the bearing 32. In some embodiments, this gap G, is substantially flat and and leaves 0.5 to 1 millimeter of space between the highest tip of the pegs from the first part 20 and the highest tip of the pegs from the second part 22. As a result, there is no active contact between the first wall 26 and the second wall 44 resulting in a frictionless configuration upon rotation of the grinding device 10. In some embodiments, the bearing 32 is hexagonal in shape and chamfered to allow for easier entry of the central axis pillar 48. In other embodiments, the bearing 32 may be square in shape or any other shape. When the second part 22 sits on top of the first part 20, herb materials of various sizes can be placed between the second pegs 54 and the first pegs 34. FIG. 8A shows a feature of the second pegs 54 and the first pegs 34 having a smaller size herb material 56. FIG. 8B shows a feature of the second pegs 54 and the first pegs 34 having a medium size herb material 58. FIG. 8C shows a feature of the second pegs 54 and the first pegs 34 having a larger size herb material 60. In one example, the distance i.e., gap G between first part 20 and second part 22 can be controlled to place herb material 56 of different sizes between first pegs 34 and second pegs 54.

In use, the herb material 56 is placed over the first pegs 34. Subsequently, the second part 22 containing the central axis pillar 48 is made to sit over the first part 20. Due to the constructional features of the grinding device 10, the central axis pillar 48 sits in the bearing 32 and ensures that the second wall 44 does not come in contact with first wall 26. This way, the central axis pillar 48 and bearing 32 become the only contact point for connecting the first part 20 and the second part 22. This configuration makes it easier to assemble and disassemble the first part 20 and the second part 22 together. In addition, in some embodiments, the bottom of the bearing 32 that the central axis pillar 48 is inserted into contains a hole that allows for any foreign matter inside that connection point to be removed. A user (not shown) twists one or both the first part 20 and second part 22 to grind herb material 56 using the first pegs 34 and second pegs 54. As there is no contact between the second wall 44 and first wall 26, there is no friction created between the first part 20 and second part 22, and hence the grinding device 10 offers a smooth, effortless operation. In addition, the herb material 56 contacts the first pegs 34 and second pegs 54, and retains its properties without contamination from the particles of the second wall 44 and first wall 26, as in the prior art.

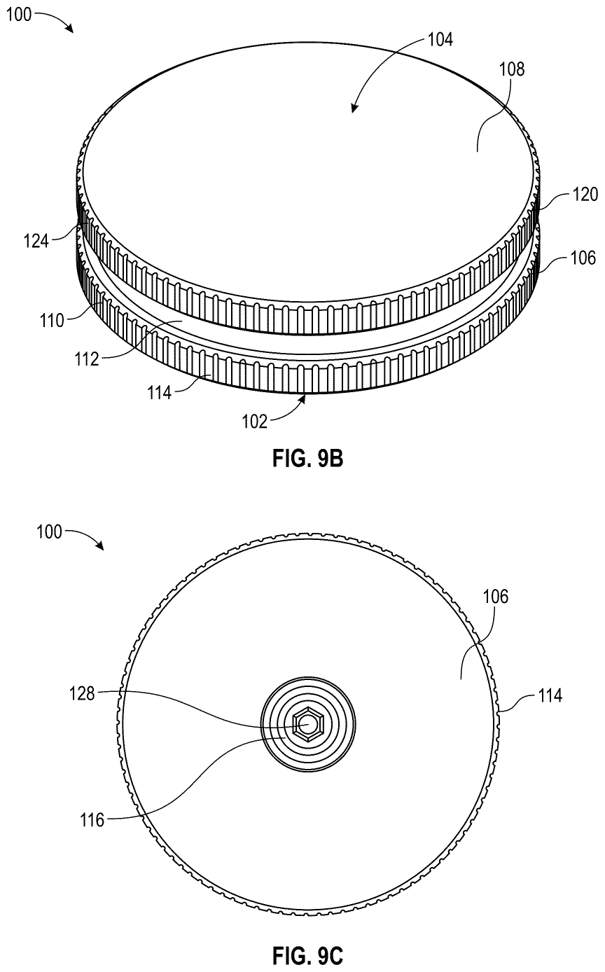

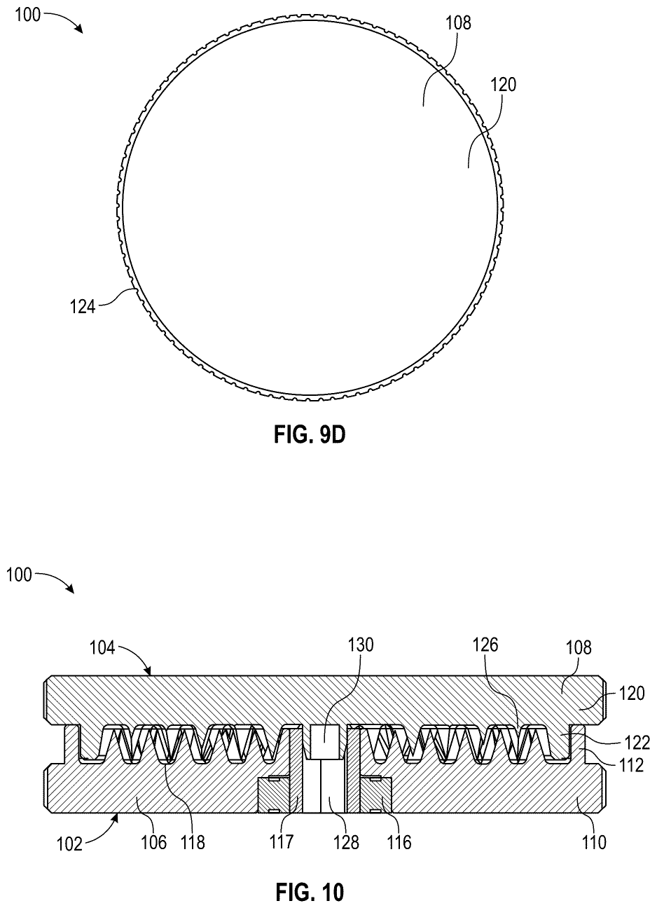

FIG. 9A, FIG. 9B, FIG. 9C and FIG. 9D show a front view, a perspective view, a bottom view and a top view, respectively of the grinding device 100, in accordance with another embodiment of the present invention. Further, FIG. 10 shows a cross-sectional view of the grinding device 100. The grinding device 100 includes a first end 102 and a second end 104. The first end 102 indicates a bottom end and second end 104 indicates a top end. The grinding device 100 includes a first part 106 and a second part 108, similar to the first part 20 and second part 22, respectively, as explained above.

The first part 106 includes a first plate 110, similar to the first plate 24, as explained above. The first plate 106 presents a first wall 112 extending towards the second end 104 from the first plate 106. In one example, the first plate 110 contains first ridges 114 at the outer portion or circumference. The first ridges 114 act as gripping portions for rotating or twisting the first part 106 with respect to the second part 108. The first plate 110 includes a bearing 116. The bearing 116 includes a pillar receiving section 117. Further, the first plate 110 encompasses a plurality of first teeth or first pegs or first bristles or first spikes 118. As explained above, the first pegs 118 can be arranged in a circular pattern. In one example, the first pegs 118 can be arranged in an irregular manner.

The second part 108 encompasses a second plate 120. The second plate 120 comes in a relatively flat configuration. Optionally, the second plate 120 comes in a curved configuration. As can be seen from at least FIG. 10, the second plate 120 presents a second wall 122. The second wall 122 extends towards the first end 102 from the second plate 120. The second wall 122 positions within the first wall 112 allowing a gap for easy twisting of the first part 106 and second part 108 without causing friction.

In one example, the second plate 120 contains second ridges 124 at the outer portion or circumference. The second ridges 124 act as gripping portions for rotating or twisting the second part 108 with respect to the first part 106. Further, the second plate 120 encompasses a plurality of second teeth or second pegs or second bristles or second spikes 126, similar to the first pegs 118 on the first plate 110. Further, the grinding device 100 encompasses a central axis pillar 130 having a shaft 128. The shaft 128 positions in a pillar receiving section 117 and helps connect the first part 106 and second part 108. Here, when the second part 108 sits on top of the first part 106, the second wall 122 sits within the first wall 112 leaving a gap G (not shown) indicating that the connection between the first part 106 and second part 108 is maintained by central axis pillar 130 sitting in the pillar receiving section 117. As a result, there is no active contact between the first wall 112 and second wall 122 resulting in a frictionless configuration, when the first part 106 and second part 108 are rotated. In some embodiments, this gap G (not shown), is substantially flat and and leaves 0.5 to 1 millimeter of space between the highest tip of the pegs from the first part 106 and the highest tip of the pegs from the second part 108. In some embodiments, the pillar receiving section 117 is hexagonal in shape and chamfered to allow for easier entry of the central axis pillar 130. In other embodiments, the pillar receiving section may also be square or any other shape. The grinding device 100 operates similar to the grinding device 10, as explained above.

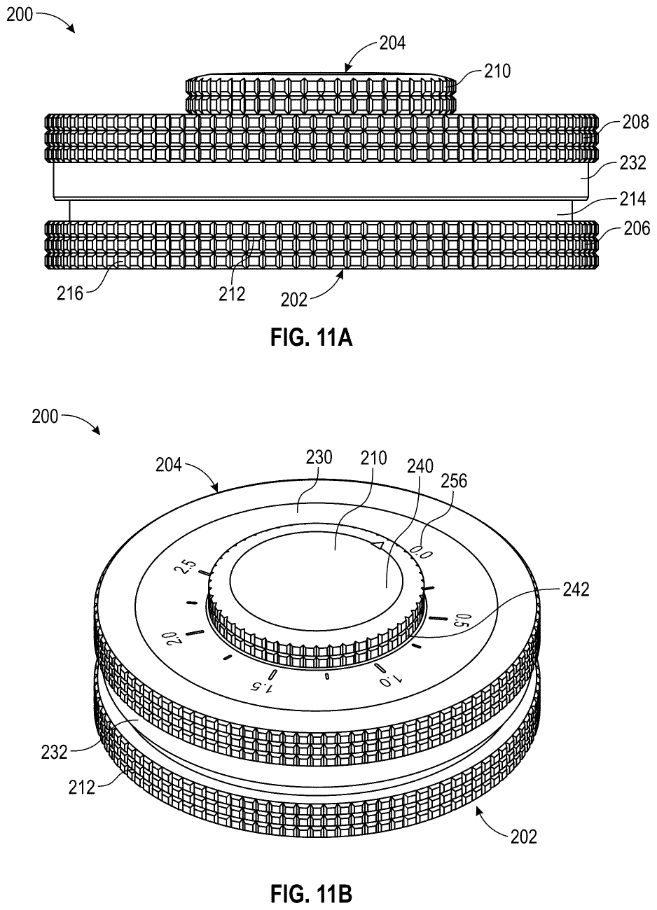

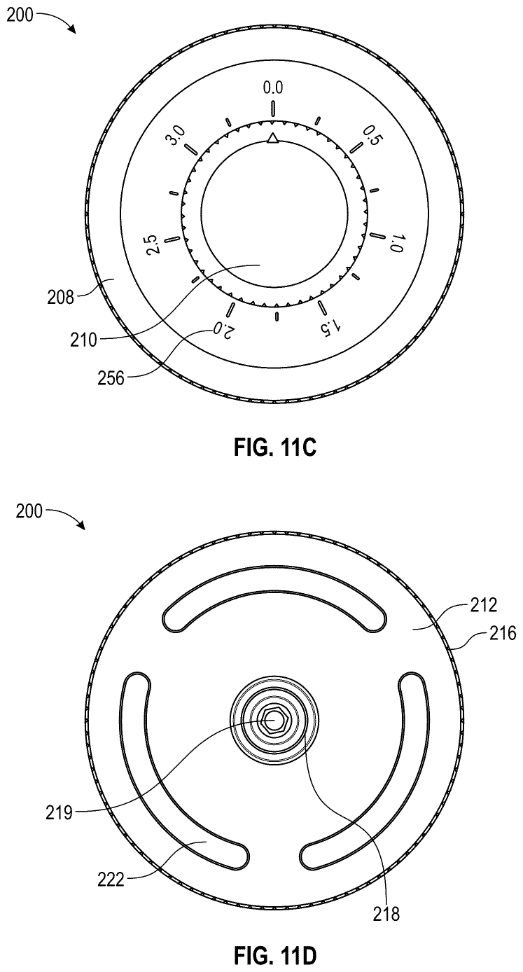

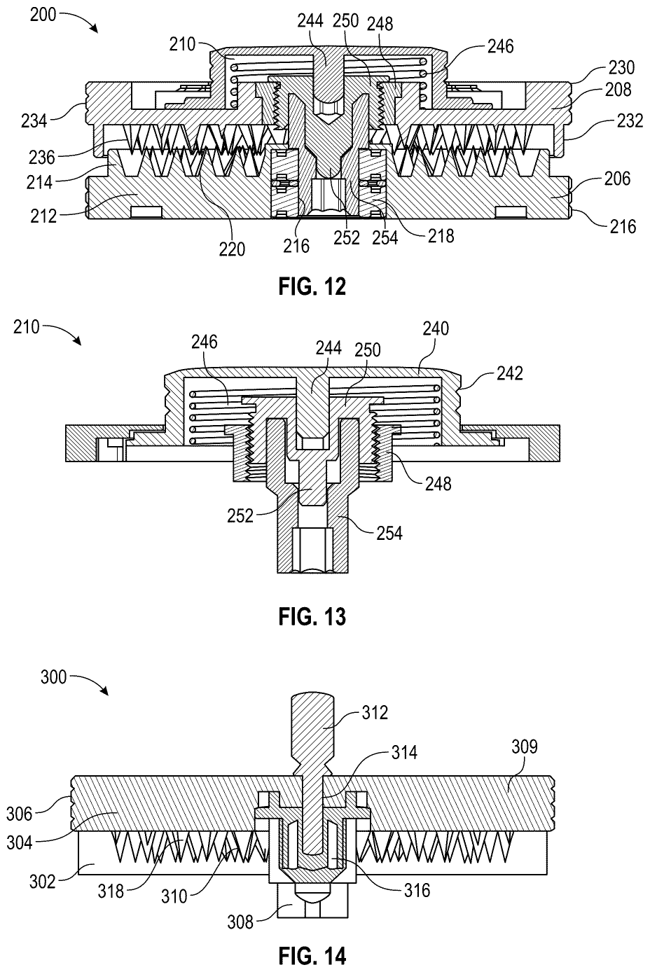

FIG. 11A, FIG. 11B, FIG. 11C and FIG. 11D show a front view, a perspective view, a top view and a bottom view, respectively of grinding device 200, in accordance with another embodiment of the present invention. Further, FIG. 12 shows a cross-sectional view of grinding device 200. The grinding device 200 includes a first end 202 and a second end 204. The first end 202 indicates a bottom end and the second end 204 indicates a top end. The grinding device 200 includes a first part 206, a second part 208, and a third part 210. The first part 206 and second part 208, are similar to the first part 20 and second part 22, respectively, as explained above. Here, the third part 210 incorporates a central axis pillar 244 that helps connect the first part 206 and second part 208 in place in a frictionless manner.

The first part 206 includes a first plate 212. The first plate 212 presents a first wall 214 extending towards the second end 204 from first plate 212. In one example, the first plate 212 encompasses first ridges 216 at the outer portion or circumference. The first plate 212 includes a bearing 218. The bearing 218 includes a pillar receiving section 254. In one example, the bearing 218 includes a nut 219. Further, the first plate 212 encompasses a plurality of first teeth or first pegs or first bristles or first spikes 220, similar to the first pegs 34, as explained above. At the bottom, the first plate 212 encompasses shoe members 222 allowing the first plate 212 to be placed on a surface without damage.

The second part 208 encompasses a second plate 230. The second plate 230 comes in a relatively flat configuration. As can be seen from at least FIG. 11, the second plate 230 presents a second wall 232. The second wall 232 extends towards the first end 202 from the second plate 230. As can be seen, the second wall 232 position is slightly larger and positions outside the first wall 212 allowing a gap for easy, frictionless twisting between the first part 206 and second part 208. In one example, the second plate 230 encompasses second ridges 234 at the outer portion or circumference. The second ridges 234 act as gripping portions for rotating or twisting the second part 208 with respect to the first part 206. Further, the second plate 230 encompasses a plurality of second teeth or second pegs or second bristles or second spikes 236, similar to the first pegs 220 on the first plate 212.

FIG. 13 shows a cross-sectional view of the third part 210, in accordance with one embodiment of the present invention. Referring to FIG. 11B, FIG. 12 and FIG. 13, the third part 210 includes a third plate 240. The third plate 240 includes third ridges 242. Further, the third plate 240 encompasses a central axis pillar 244. The central axis pillar 244 has a shaft 252 that sits within the pillar receiving section 254. Optionally, the third plate 240 includes a connector 248 connecting around the central axis pillar 244 via a spring member 246. The spring member 246 helps to rotate the third part 210 at defined depth 256, as shown in FIG. 11B, for example. The defined depth 256 ranges from 0.0 to 3.5 millimeters, but may be different in other embodiments of the invention and have an even greater range. In one example, the third part 210 is operated to control the distance between the first part 206 and second part 208 such that grinding device 200 can be used to grind herb material of different sizes, as illustrated in FIG. 8A, FIG. 8B, and FIG. 8C, for example.

Here, when the second part 208 sits on top of the first part 206, the second wall 232 sits within the first wall 214 leaving a gap indicating that the connection between the first part 206 and the second part 208 is maintained by the central axis pillar 244 sitting in a pillar receiving section 218. As a result, there is no active contact between the first wall 214 and second wall 232, which avoids friction when the first part 206 and second part 208 are rotated. In operation, the user adjusts the third part 210 using the markings/depth 256 defining the distance between the first part 206 and second part 208. Further, the user rotates of the third part 210 causing the second part 208 to rotate, which in turn causes the second pegs 236 to rotate for grinding the herb material with the first pegs 220. As specified above, the third part 210 helps control the distance between the first part 206 and second part 208. As a result, the grinding device 200 can be used to grind herb material of different sizes, as illustrated in FIG. 8A, FIG. 8B, and FIG. 8C, for example.

The hole at the bottom of the shaft 252 that sits within the pillar receiving section 254, allows for foreign matter to be removed from the grinding device 200.

FIG. 14 shows a cross-sectional view of a grinding device 300, in accordance with another embodiment of the present invention. The grinding device 300 includes a first part 302 and a second part 304, similar to the first part 20 and second part 22, respectively, as explained above. Here, only the second part 304 has ridges 306. The first part 302 includes a bearing 308 that extends from first part 302. Second part 304 encompasses a plurality of first teeth or first pegs or first bristles or first spikes 310. Further, the second part 304 encompasses a second plate 309. As can be seen, the first part 302 and second part 304 are flat. The first pegs 310 are positioned at the first part 302 and the second pegs 318 of the second part 304 are made to operationally contact first pegs 310.

In accordance with the present embodiment, the grinding device 300 includes a central axis pillar 312 having a shaft 314. The shaft 314 sits within a pillar receiving section 319 of bearing 308. Here, the first part 302 and second part 304 are connected via the central axis pillar 312 with a slight gap G (not shown) provided between the first part 302 and second part 304 to avoid active contact. In some embodiments, this gap G (not shown) ranges from 0.5 to 1.0 millimeters of space between the highest tip of the pegs from the first part 302 and the highest tip of the pegs from the second part 304. This helps to avoid friction between the first part 302 and second part 304 when they are rotated for grinding the herb material with the first pegs 310 and second pegs 318. In some embodiments, the pillar receiving section 319 of the bearing 308 is hexagonal in shape and chamfered to allow for easier entry of the central axis pillar 312. In other embodiments, the shape of the pillar receiving section 319 is square and other shapes may be used.

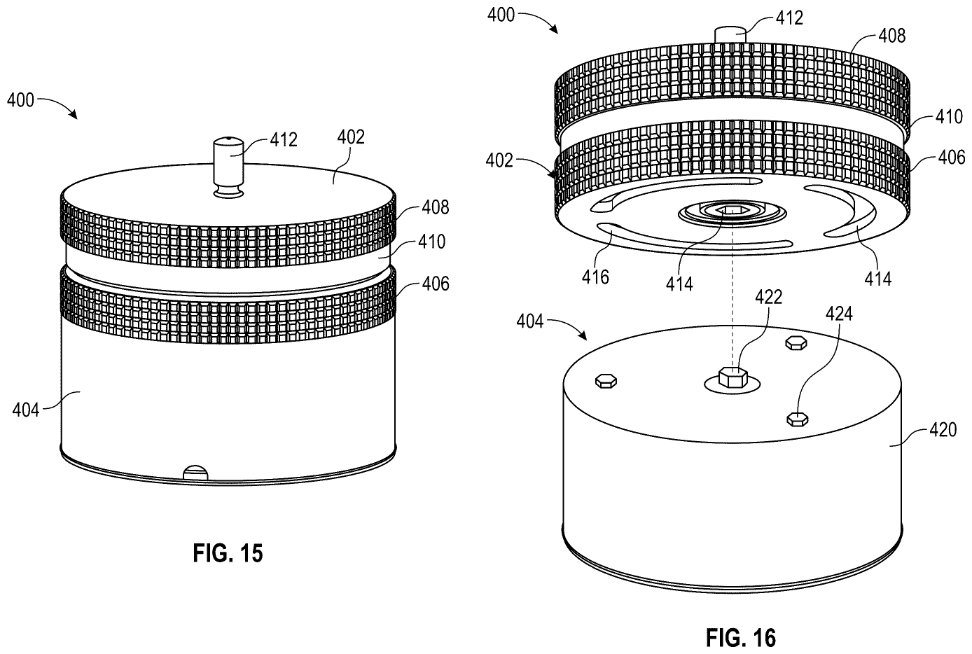

FIG. 15 and FIG. 16 shows a perspective view and an exploded view, respectively of grinding device 400, in accordance with yet another embodiment of the present invention. The grinding device 400 presents a device 402 and a motor assembly 404. Here, a motor 420 is used to operate the device 402 for grinding the herb material. The grinding device 400 encompasses a first part 406 and a second part 408, similar to the first part 20 and second part 22, as explained above. Here, a second wall 210 of the second part 408 sits around a first wall (not shown) of the first part 406. Further, the device 402 includes a central axis pillar 412. As specified above, the central axis pillar 412 acts as a bridge/connection point between the first part 406 and second part 408. Further, the first part 406 encompasses a motor receiver portion 414. Additionally, the first part 406 has grooves or channels 416 for connecting the motor assembly 404.

The motor assembly 404 has a motor body 420. The motor body 420 presents a connecting body 422. The connecting body 422 inserts in motor receiver portion 414 and transfers the required power for rotating the first part 406 from motor 404. Further, the motor body 420 includes male members 424. The male members 424 insert in grooves 416 and allow forward and rearward movement of the first part 406 with respect to motor body 420 such that the first pegs (not shown) within the first part 406 can grind the herb material with the second pegs (not shown) within the second part 408. The present embodiment is presented to illustrate a motorized version of the grinding device 10, as explained above.

The hole at the bottom of the bearing 32 allows for foreign matter to be removed from the grinding device 400.

The presently disclosed grinding device or herb grinding device provides several advantages over the prior art. The grinding device offers a novel design that avoids the drawbacks of traditional grinding devices that lead to friction and contamination. The presently disclosed grinding device presents a central axis pillar that allows both the top and bottom grinding plates to suspend with the help of a low-friction bearing system. This allows the plates to rotate smoothly with little effort from the user while preventing any plate-on-plate physical contact that could shed particulates into the grind material. In addition, the grinding device can be operated manually by the user or can be connected to a motor for operating it for grinding the herb material. This dual manual/automated capability provides flexibility for different consumer preferences and needs. For example, a user may adjust the height between the first plate and the second plate from 0.0 to 3.5 millimeters by turning the dial that raises the upper plate, as shown in FIG. 11C, depending on the size of the herbs a user may want to insert into the grinding device, and the size of the preferred grind.

A person skilled in the art appreciates that the grinding device can come in a variety of shapes and sizes depending on the need and comfort of the user. Further, many changes in the design and placement of components may take place without deviating from the scope of the presently disclosed grinding device.

In the above description, numerous specific details are set forth such as examples of some embodiments, specific components, grinding devices, methods, in order to provide a thorough understanding of embodiments of the present subject matter. It will be apparent to a person of ordinary skill in the art that these specific details need not be employed, and should not be construed to limit the scope of the subject matter.

In the development of any actual implementation, numerous implementation-specific decisions must be made to achieve the developer's specific goals, such as compliance with system-related and business-related constraints. Such a development effort might be complex and time-consuming, but may nevertheless be a routine undertaking of design, fabrication, and manufacture for those of ordinary skill. Hence as various changes could be made in the above constructions without departing from the scope of the subject matter, it is intended that all matter contained in the above description or shown in the accompanying drawings shall be interpreted as illustrative and not in a limiting sense.

The foregoing description of embodiments is provided to enable any person skilled in the art to make and use the subject matter. Various modifications to these embodiments will be readily apparent to those skilled in the art, and the novel principles and subject matter disclosed herein may be applied to other embodiments without the use of the innovative faculty. It is contemplated that additional embodiments are within the spirit and true scope of the disclosed subject matter.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A grinding device, comprising:
a first plate comprising a plurality of first pegs;
a second plate comprising a plurality of second pegs;
a first wall extending from an outer circumference of the first plate;
a second wall extending from an outer circumference of the second plate;
a bearing positioned at the first plate;
a central axis pillar positioned at the second plate;
and wherein the central axis pillar connects to the bearing such that said first wall and second wall do not have an active contact while the plurality of first pegs and the plurality of second pegs operatively connect to grind herb materials.

2. The grinding device of claim 1, wherein the central axis pillar comprises a head and a shaft extending from the head.

3. The grinding device of claim 1, further comprises a motor, wherein the motor operatively connects to the first plate and rotates one of the first plate and the second plate for grinding the herb material.

4. The grinding device of claim 1, further comprises a third plate, wherein the third plate positions over the second plate and is connected to the central axis pillar, and wherein the third plate controls a distance between the first plate and the second plate such that a grind level is controlled for grinding the herb material of different sizes;

5. The grinding device of claim 1, wherein each of said first plate and said second plate comprises ridges at their respective circumferences providing a grip for rotating said first plate or said second plate.

6. The grinding device of claim 1, wherein each of said first peg and said second peg has a base, a tapered section extending from said base, and a tip at a distal end of said tapered section.

7. The bearing of claim 1, wherein the bearing has a chamfered hexagonal entry point for the central axis pillar.

8. The grinding device of claim 1, wherein said first pegs and said second pegs are arranged in a concentric circular configuration on said first plate and said second plate, respectively.

9. A method for grinding leaves with a grinding device, the method comprising:
providing a first plate comprising a plurality of first pegs;
providing a second plate comprising a plurality of second pegs;
providing a bearing positioned at said first plate;
providing a central axis pillar positioned at said second plate;
inserting the leaves on one of said first or second plates;
connecting the central axis pillar to the bearing, such that the first plate and the second plate do not have an active contact while the plurality of pegs operatively connect for grinding of herb material; and
turning one of said first or second plates to grind the leaves;

10. The method of claim 9, further comprising:
providing a first wall at a circumference of the first plate, the first wall extending from a surface of the first plate; and
providing a second wall said at a circumference of the second plate, wherein the second wall extends from a surface of the second plate.

11. The method of claim 9, wherein an outer portion of the first wall and the second wall contains ridges.

12. The method of claim 9, wherein during the step of inserting the central axis pillar into the bearing, a gap between the plurality of first pegs and the second plate and the plurality of second pegs and the first plate ranges between 0.5 and 1.0 millimeters.

13. The method of claim 9, wherein the plurality of shaped pegs have a base resting against the first plate, a tapered section extending from the base, and a tip at a distal end of the tapered section.

14. The method of claim 9, further comprising controlling a distance between said first plate and said second plate such that a grind level is controlled for grinding said herb material of different sizes.

15. A grinding device, comprising:
a first plate comprising a plurality of first pegs;
a second plate comprising a plurality of second pegs;
a bearing positioned at said first plate;
a motor operatively connecting at said first plate; and
a central axis pillar positioned on said second plate, wherein said central axis pillar inserts in said bearing such that said first plate and said second plate do not have an active contact while said plurality of first pegs and said plurality of second pegs operatively connect for grinding an herb material, and wherein said motor causes said first plate to rotate for grinding said herb material with said first pegs and said second pegs.

16. The grinding device of claim 15, wherein each of said first peg and said second peg has a base, a tapered section extending from said base, and a tip at a distal end of said tapered section.

17. The grinding device of claim 15, wherein said first pegs and said second pegs are arranged in a concentric circular configuration on said first plate and said second plate, respectively.

18. The grinding device of claim 15, wherein said first plate comprises a first wall at its circumference, wherein said first wall extends from a surface of said first plate, wherein said second plate comprises a second wall at its circumference, and wherein said second wall extends from a surface of said second plate.

19. The grinding device of claim 18, wherein said first wall and said second wall present a gap indicating no contact between them when said second plate sits on top of said first plate.

20. The grinding device of claim 15, wherein said central axis pillar comprises a head and a shaft extending from said head, and wherein said shaft connects to said bearing.
